(19) United States
(12) Patent Application Publication
(10) Pub. No.: US 2005/0154640 A1
(43) Pub. Date: Jul. 14, 2005

(54) Context- and behavior-based targeting system

(76) Inventors: Venkateswarlu Kolluri, Shrewsbury, MA (US); Alden Dorosario, South Grafton, MA (US)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 10/990,754

(22) Filed: Nov. 17, 2004

Related U.S. Application Data
(60) Provisional application No. 60/520,630, filed on Nov. 17, 2003.

(51) Int. Cl. G06F 17/60

(52) U.S. Cl. 705/14

(57) ABSTRACT

A method is disclosed for enabling relevant and targeted information/service exchange between information/service providers (i.e., suppliers) and information/service seekers (i.e., customers) using a content and behavior-based contextual targeting system as the information-brokering agent. Additionally, another method is disclosed for tracking and optimizing relevant and targeted information/service exchange between suppliers and customers across different transaction-based payment models, such as cost per thousand impressions, cost per transaction and cost per acquisition. Finally, a method for intelligent real-time information seeking across a distributed computer-network to find relevant and targeted information/services offered by information/service providers to the information/service seekers is also disclosed.

### CLAIM TO BENEFIT OF EARLIER FILED PROVISIONAL APPLICATION

This Utility Patent Application claims the benefit of the filing date of the following earlier filed and co-pending U.S. Provisional Patent Application entitled “CONTEXT- AND BEHAVIOR-BASED TARGETING SYSTEM (CbeT)”, filed Nov. 17, 2003, having U.S. Ser. No. 60/520,630 and sharing co-inventorship with the present invention. The entire disclosure, teachings and contents of this referenced provisional patent application are hereby incorporated by reference in their entirety.

### BACKGROUND

This patent application hereby incorporates by reference the entire contents of the following published U.S. patent application: Publication number 20020123912, Filed Dec. 5, 2002, entitled “Internet contextual communication system” as background material.

Internet advertising allows web sites to obtain ad content and display the ad content adds to users who visit those web sites using web browser software. Companies that provide the content for the advertisements typically arrange a payment system with the web site ad displayers (e.g., developers and owners of those sites that display ads, such as in banner, pop-up windows, etc.) such that if a consumer clicks on an advertisement that he or she sees on a web site, the consumers browser will be directed to a web site specific to the advertisement to promote a specific product or service. In exchange for this, the company owning the web site specific to the advertisement (i.e., the company who product is being promoted) will pay a small amount of money (e.g., 5 cents) to the web site who posted the advertisement that the consumer clicked upon. This is referred to as pay-per-click through. In this manner, web sites that operate to display advertisements on behalf of companies that sell products and services can generate revenue for each click-through.

### SUMMARY

Conventional web-based revenue models suffer from deficiencies since there is no specific tracking done of which advertisements displayed to consumers from which advertising providers and for which products generate the most amount of money for the web site advertisement displayers (i.e., the site that displays the add to consumer in the first place). Embodiments of the invention significantly overcome this and other concerns.

Embodiments of the invention include a method for enabling relevant and targeted information/service exchange between information/service providers (i.e., suppliers) and information/service seekers (i.e., customers) using a content and behavior-based contextual targeting system as the information-brokering agent.

Another embodiment includes a method for tracking and optimizing relevant and targeted information/service exchange between suppliers and customers across different transaction-based payment models, such as cost per thousand impressions, cost per transaction and cost per acquisition.

Yet another embodiment includes method for intelligent real-time information seeking across a distributed computer-network to find relevant and targeted information/services offered by information/service providers to the information/service seekers.

Other embodiments of the invention include a any type of computerized device to process any or all of the method operations disclosed herein as embodiments of the invention. Still other embodiments of the invention include software or firmware programs that can operate alone or in conjunction with each other in a computerized device to perform the method embodiment steps and operations summarized above and disclosed in detail below. One software embodiment comprises a computer program product that has a computer-readable medium including computer program logic encoded thereon that, when performed in a computerized device having a coupling of a memory and a processor, programs the processor to perform the processing operations explained herein. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM or RAM or PROM chips or as an Application Specific Integrated Circuit (ASIC). The software or firmware or other such configurations can be installed onto the computerized device to cause the computerized device to perform the techniques explained herein as embodiments of the invention. Thus, software code written upon any computer readable medium that contains instructions to carry out novel combinations of processing steps as explained herein, or any equivalents thereto, is considered an embodiment of the invention.

It is to be understood that the system of the invention can be embodied strictly as a software program, as software and hardware, or as hardware alone (e.g., such as in a dedicated network device).

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention.

FIGS. 1A through 1D and 2 through 12 illustrate embodiments of the invention.

### DETAILED DESCRIPTION

One embodiment of the invention presents a targeting system to find and present targeted and relevant content/services/offers/promotions/advice and/or recommendations to customers seeking information/services on the Internet or a network of computer devices such as PDA's, cell phones and other networked wireless devices. This invention is not restricted to just profiling and targeting customers/visitors on the Internet; it is applicable as an information brokering system for handling any transaction that can take advantage of contextual and behavioral information to improve the efficacy of the transaction and/or information/service recommendation under consideration.

This invention is directed to a scheme where two sets of “signatures” are maintained: customer-signature and supplier-signature, and a matching algorithm is used to map the two signatures to generate an effective transaction between the customer and the supplier.

Signature consists of two components: short-term component and long-term component.

The short term component of the customer-signature consists of information pertaining to the current transaction and/or customers information need (for example an online session on the internet), such as the set of urls/webpages (and their related content) visited by the user and/or the set of search-keywords (as and when available) used by the customer during the session under consideration, geographical (regional) information pertaining to the current transaction, information related to the time of the transaction etc.

The long term component of the customer-signature consists of information (as available) on customer-centric demographics data such as age, gender, etc, and also historical information about the customers past behavioral data, such as frequency counts and distributions for the set of locations/urls/sites/webpages visited by the user in the past; keywords (with counts) most frequently used by the user, topic/category interests )either inferred from users past activities or from any user-registrations data), the set of keyword categories based on the set of keywords used by the user in the past etc, regional (i.e., geographical) information about the user (either inferred from users past activities or from any available registrations data), day-part time information from past activity data.

The short-term component of the supplier-signature might consist of the information that the supplier is displaying to the user during the transaction under consideration. For example, the contents of the page/information/service being supplied to the customer, the structural information pertaining to the location of the supplier's information/service source (for example the location of the web page on the web site, the information/service category, etc.

The long-term component of the supplier-signature might consist of supplier-specific information such as the nature of the business, set of products/services that the supplier is offering (or can offer in the future), data about any information/service being offered by the businesses who partnered with the supplier under consideration (for example any offers/promotions for other third party vendors that the supplier agreed to promote) etc.

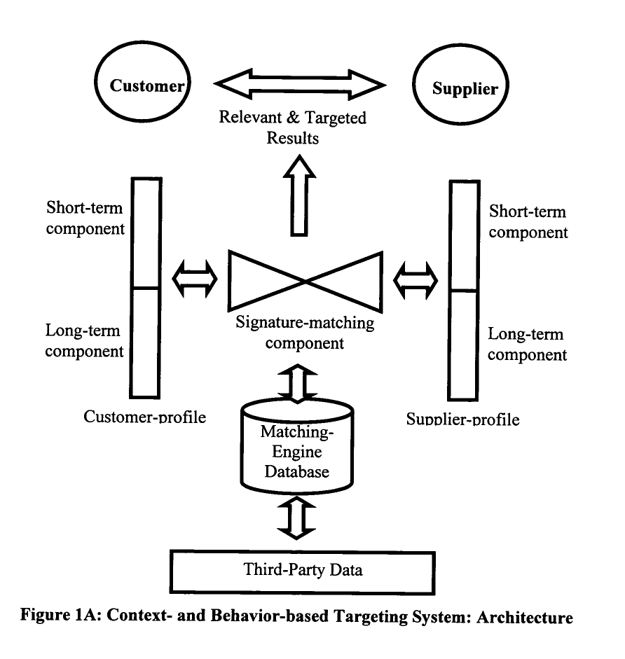

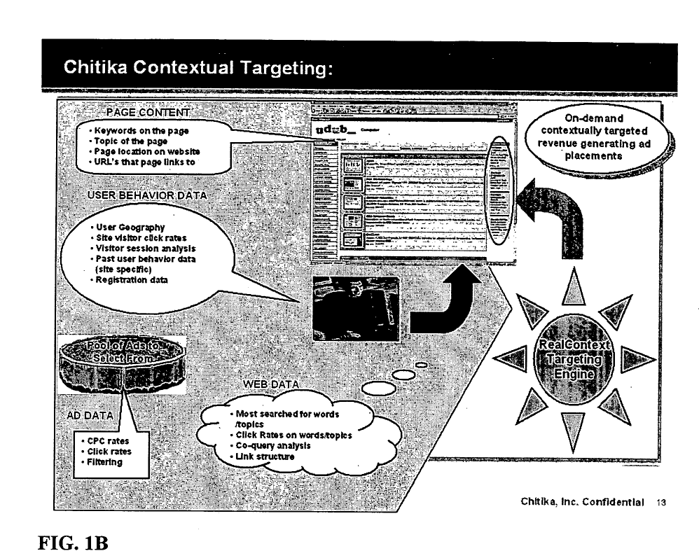

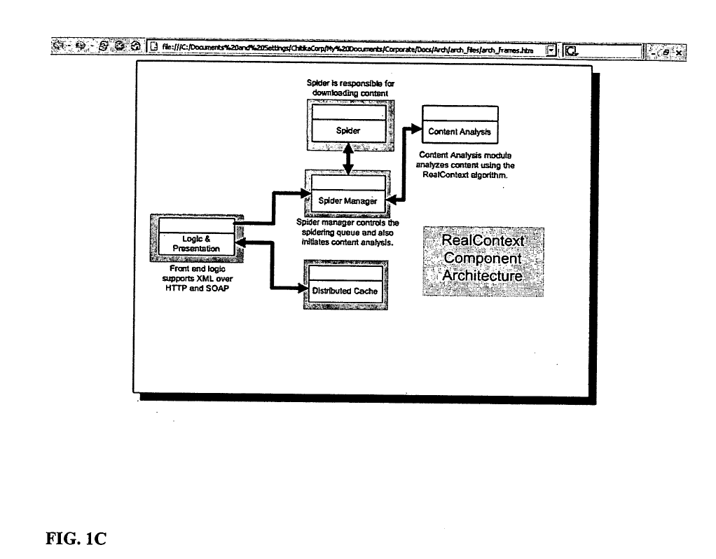

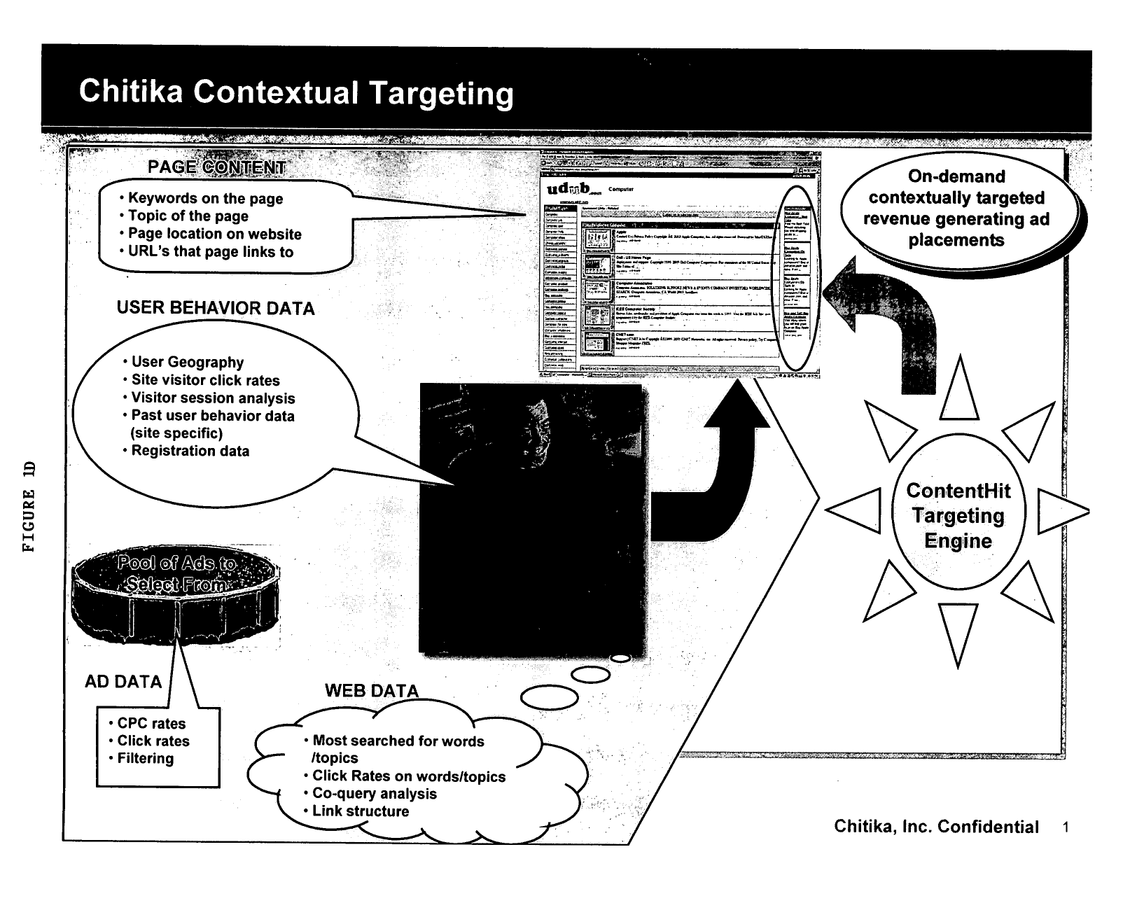

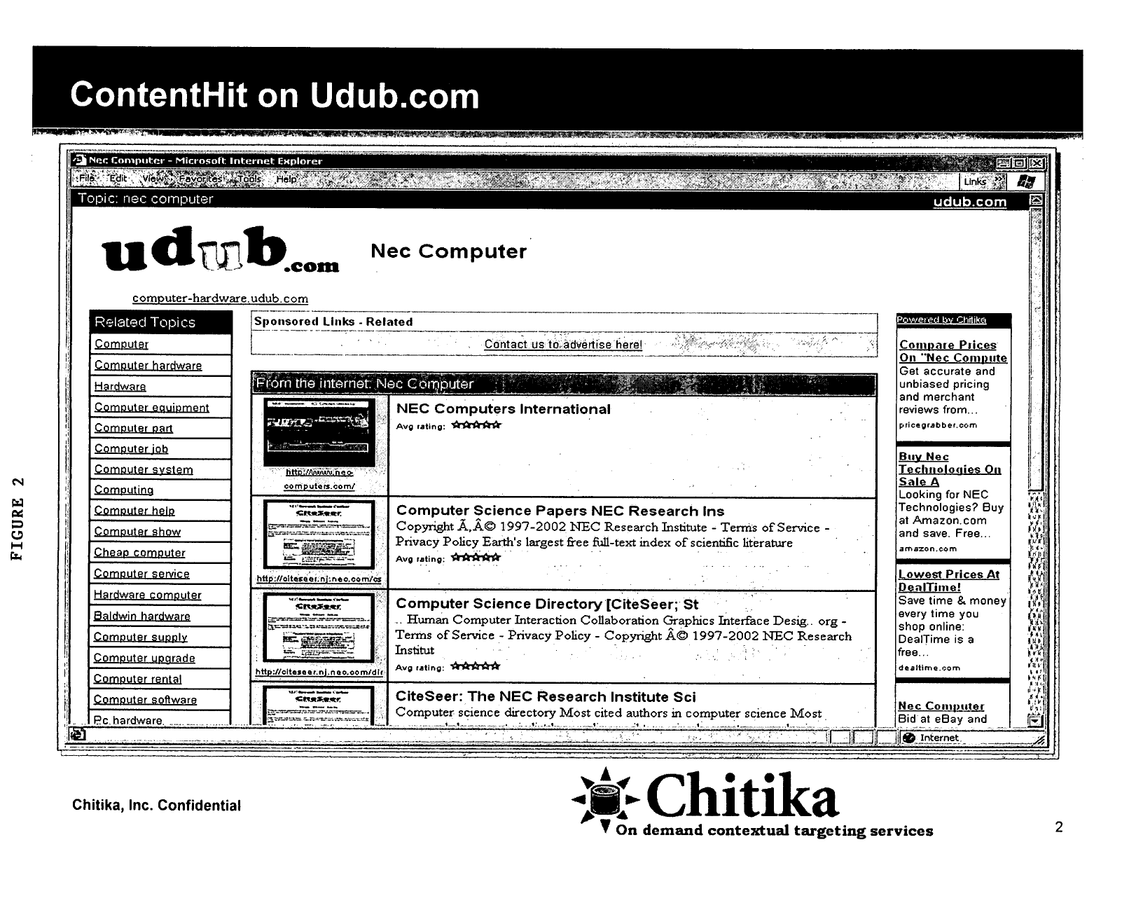

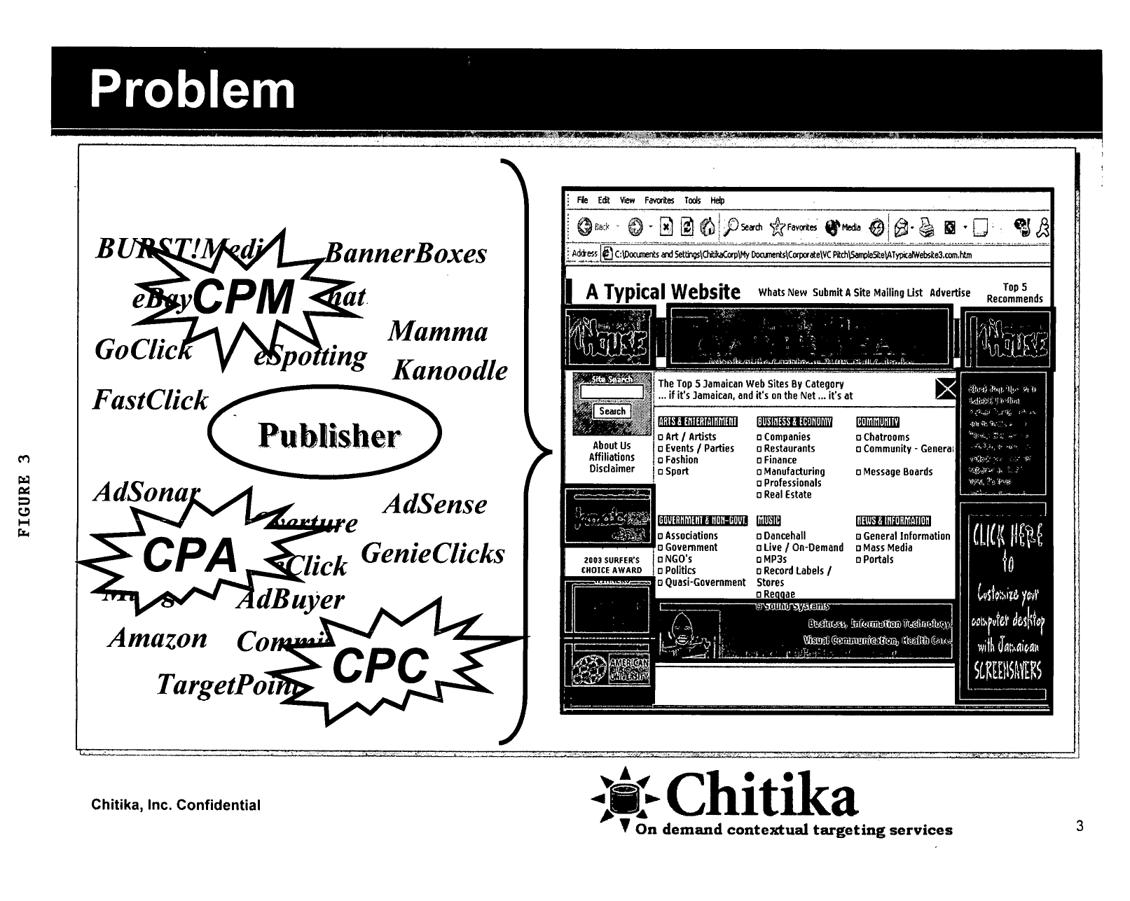

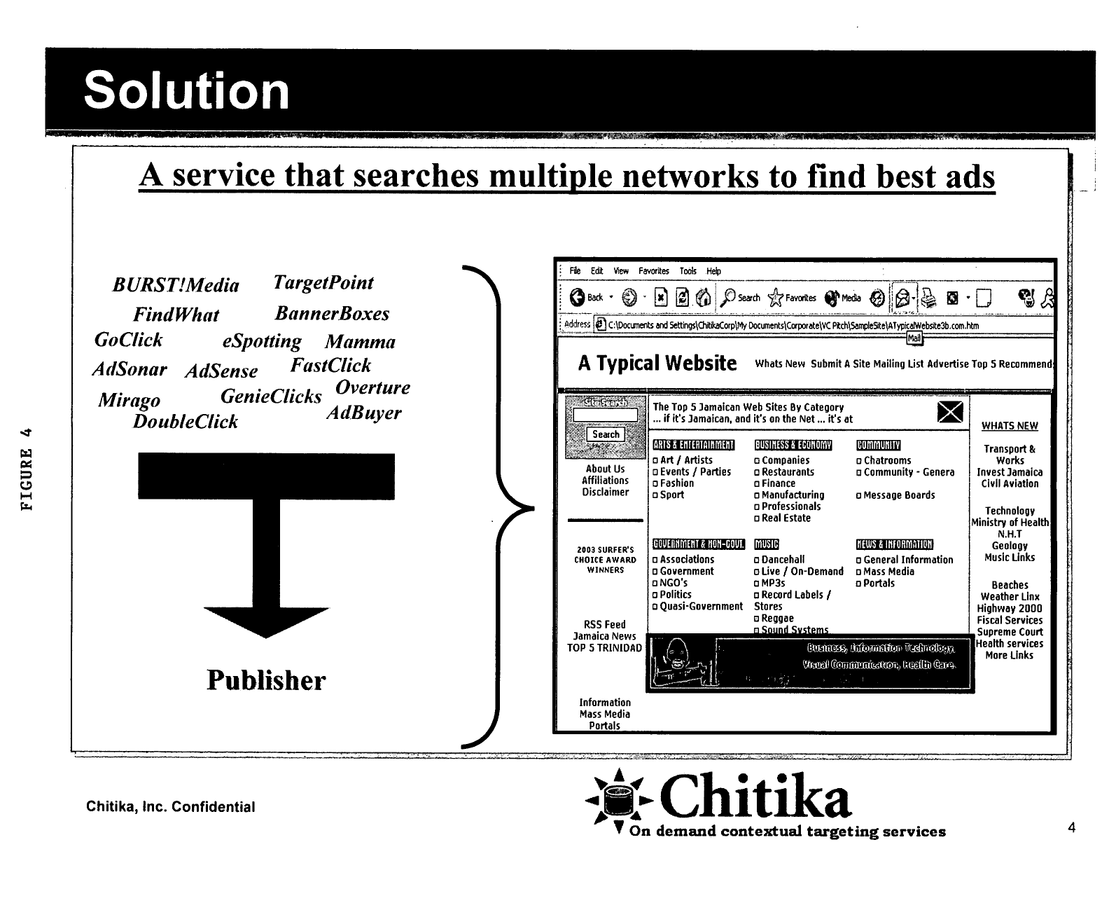

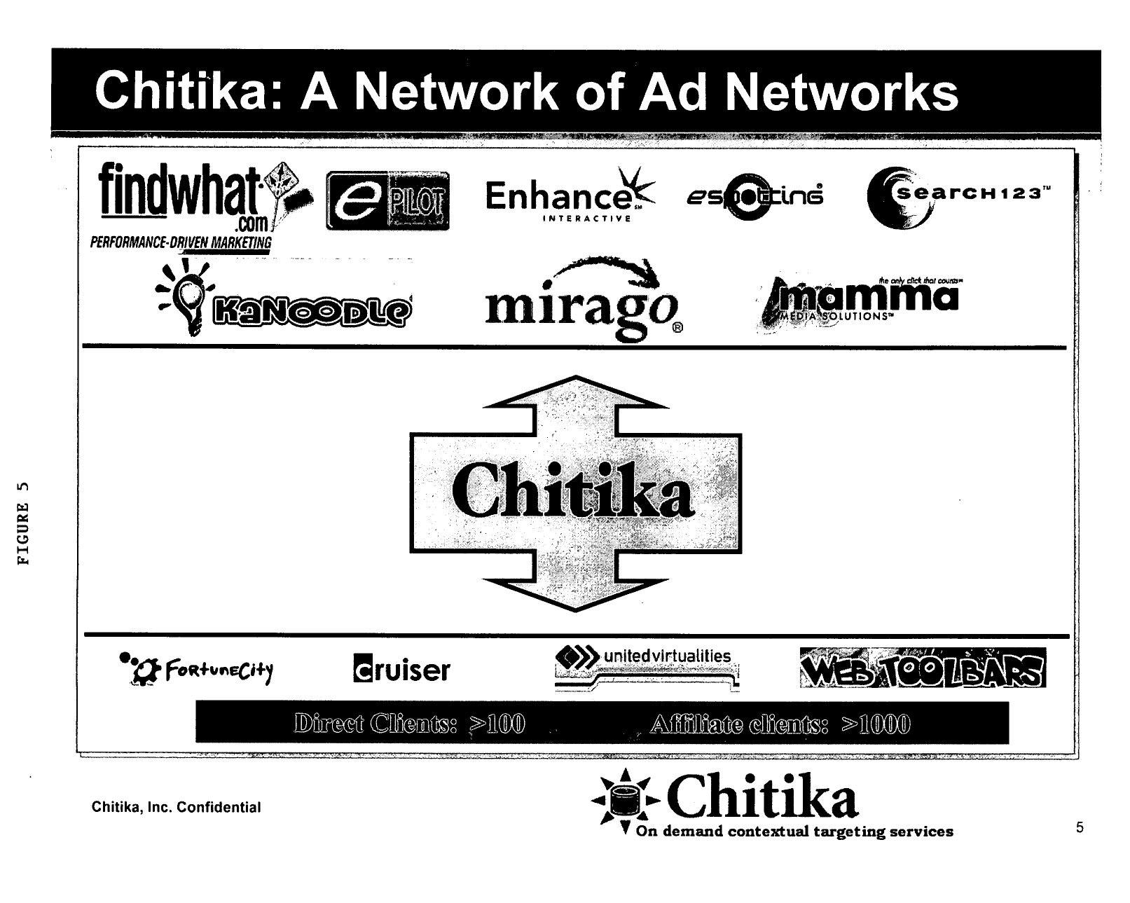

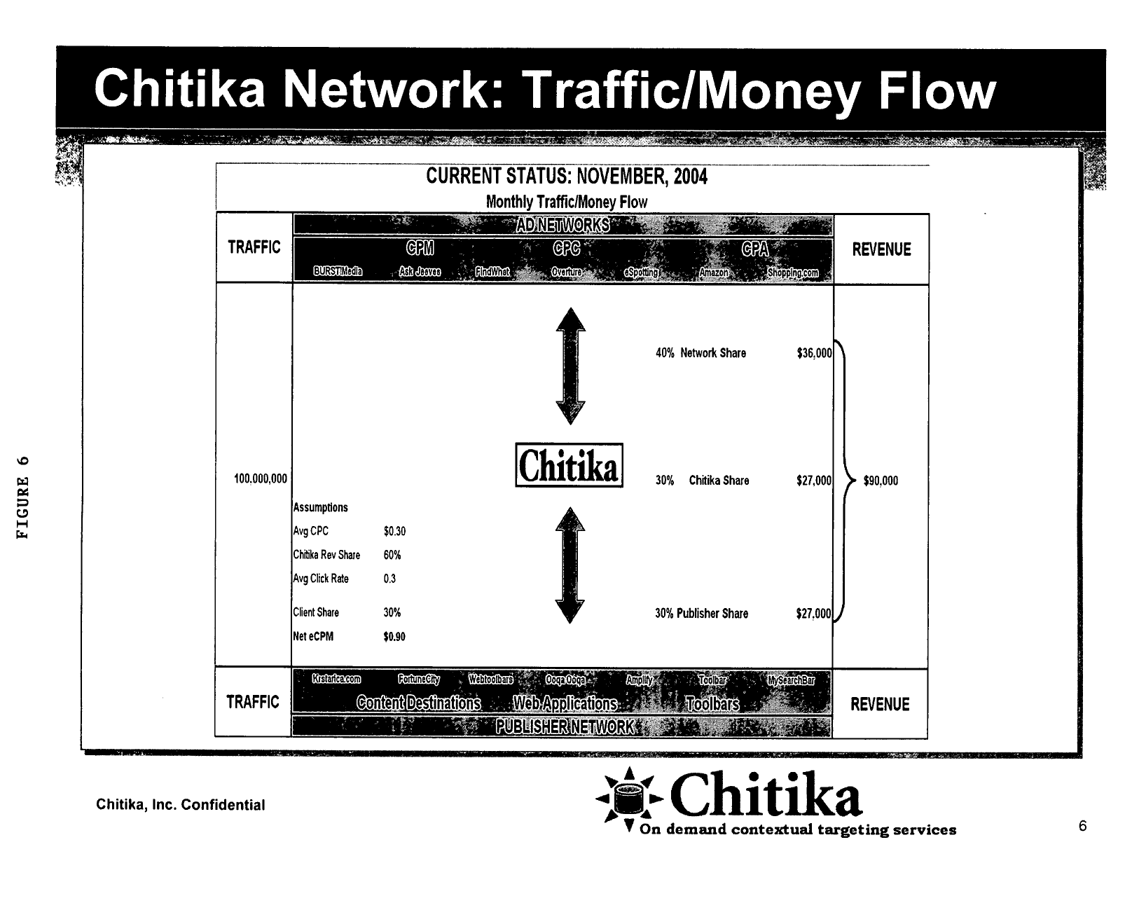

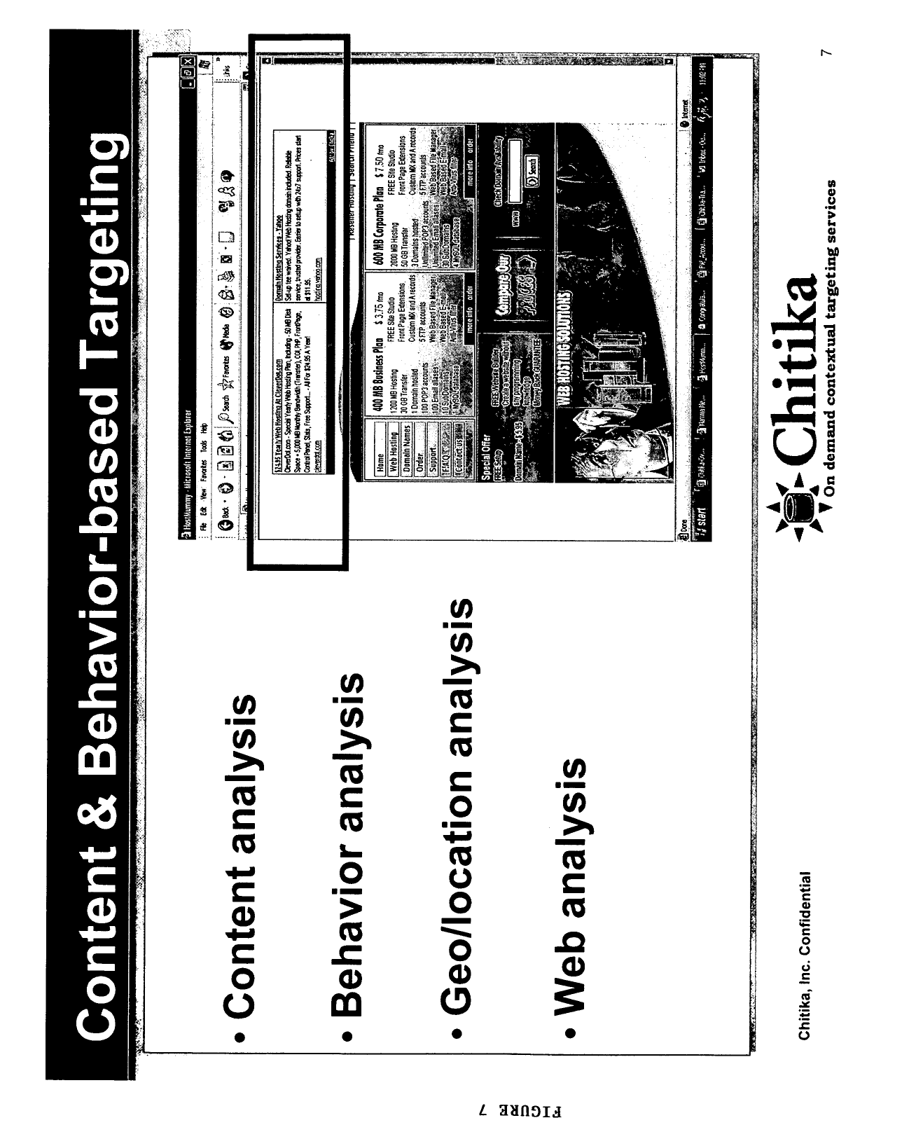

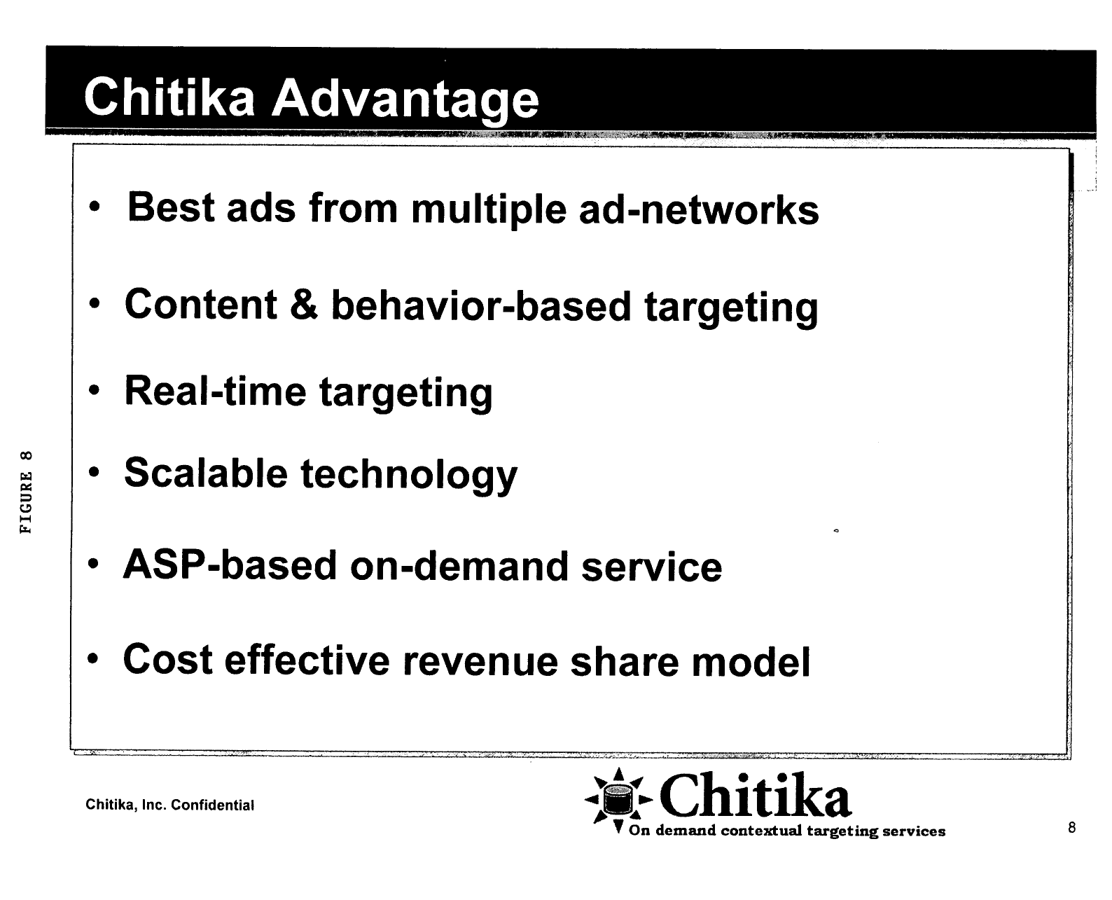

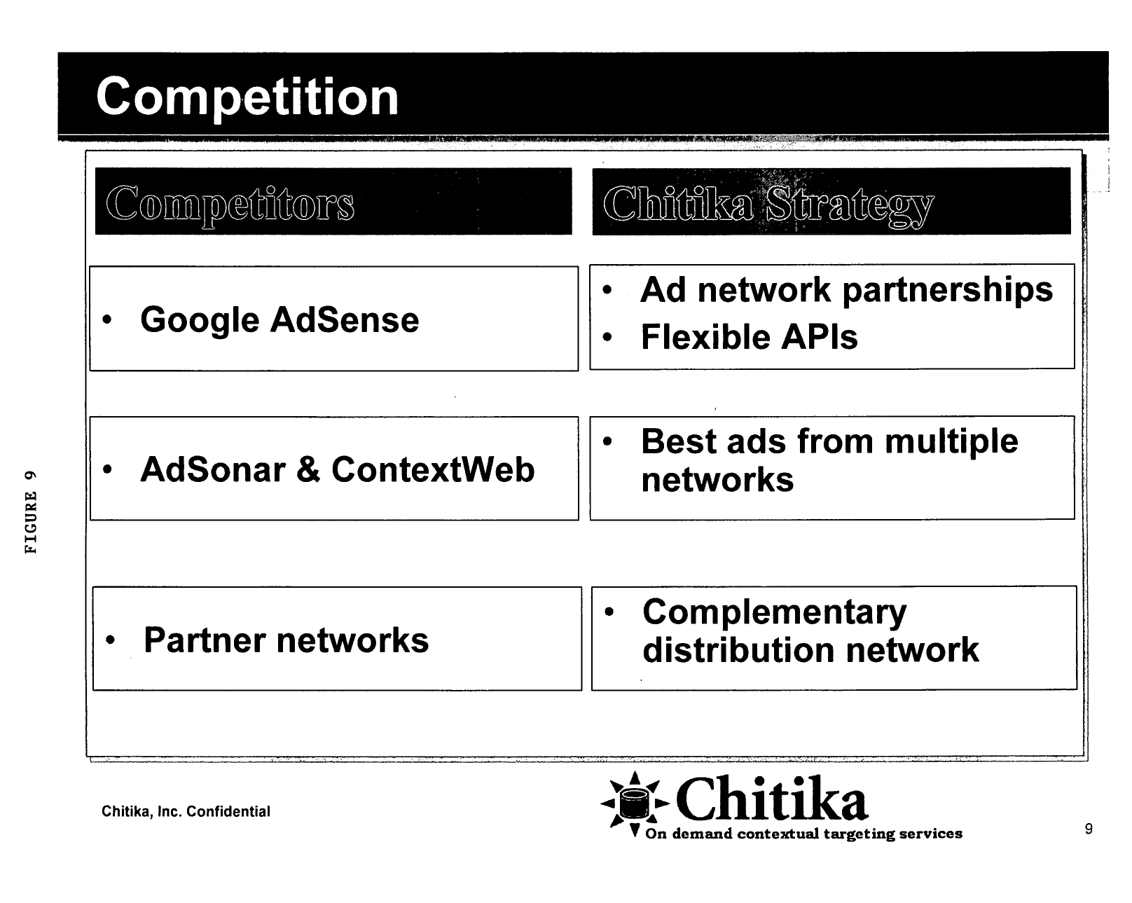

Refer to FIG. 1A for a diagram of Context- and Behavior-based Targeting System Architecture

Third-Party Data Signature might consist of data about third party content providers who are interested in paying information/service providers (i.e., suppliers) to display their content as recommendations or related “sponsored links” to the information/service seekers (i.e., customers) Third-party Data signature might consist of a set of keywords, topics, that describe the content, information about payment model, and revenue amount.

Signature Profile:

A typical signature consists of an array of fields (with associated values) and a weighting factor:

```
Signature Data Structure:
    <field_weight1><field_name1><field_value1>
    <field_weight2><field_name2><field_value2>
    ...
    <field_wieghtN><field_nameN><field_valueN>
```

### EXAMPLE

Short-term Customer Signature:
<0.3><current_url>www.myworld.com
<0.2><previous_url_1>www.travel.com
<0.1><location_zipcode><01545>

The customer-signature is matched with the supplier-signature to generate a combined “session_signature” which is then matched with the “Third-party” signature to find the most relevant and targeted third_party content that can be displayed to the customer, along with the information that the customer is seeking from the supplier.

Vector-Matching: A weighted vector matching process is used to infer the angled and Euclidean distances between vectors to find the best matching “third-party” vector. The matching results will be returned in sorted order based on a combination of angular and weighted Euclidean distance metrics.

Refer to FIG. 1B for a Contextual Targeting Diagram

Another embodiment of the invention also presents a multi-model based revenue optimization engine that constantly tracks and monitors the gross revenues generated by displaying and/or recommending content and/or services from various third-party providers, each using several different types of payment models: CPM, CPA, CPC etc.

Refer to FIG. 1C for a Real Context Component Architecture

The optimization function is essentially a weighted linear function that is used to compute the expected revenues (eRPM) generated by using a combination of CPM, CPA and CPC based third-party content/services. A multi-layered neural net model is used to train and optimize the weights for each factor in the eRPM function which is a combination of the number of times listings from CPM, CPC and CPA based models are used.

Another embodiment of the invention also claims a method for parallel and distributed spidering process to dynamically connect with multiple sources of third party information/service providers and select the relevant content/service with the highest revenue opportunity for the user session under consideration.

1. A method for enabling relevant and targeted information/service exchange between information/service providers (i.e., suppliers) and information/service seekers (i.e., customers) using a content and behavior-based contextual targeting system as the information-brokering agent.

2. A method for tracking and optimizing relevant and targeted information/service exchange between suppliers and customers across different transaction-based payment models, such as cost per thousand impressions, cost per transaction and cost per acquisition.

3. A method for intelligent real-time information seeking across a distributed computer-network to find relevant and targeted information/services offered by information/service providers to the infornation/service seekers.
